(19) United States
(12) Patent Application Publication
(10) Pub. No.: US 2011/0155254 A1
(43) Pub. Date: Jun. 30, 2011

(54) FLUID FLOW ROUTING

(76) Inventor: Roy James Swindells, Seascale (GB)

(21) Appl. No.: 13/060,261

(22) PCT Filed: Aug. 27, 2009
(86) PCT No.: PCT/GB09/51077

§ 371 Date: Feb. 22, 2011

(30) Foreign Application Priority Data
Aug. 28, 2008 (GB) 0815670.5

(51) Int. Cl. F16K 11/085

(52) U.S. Cl. 137/1; 137/625.41

(57) ABSTRACT

An apparatus, system and method for selecting a flow path for a flow of fluid are disclosed. The apparatus includes a housing comprising at least a first pipeline port, a second pipeline port and a third pipeline port; and a diverting member rotatably mounted within the housing and comprising a fluid flow channel; wherein the diverting member is rotatable between at least a first position in which the fluid flow channel is in fluid communication with the first pipeline port and the third pipeline port and a second position in which the fluid flow channel is in fluid communication with the second pipeline port and the third pipeline port.

### FIELD OF INVENTION

The present invention relates to a method and apparatus for selectively routing and re-routing the flow of fluid along a fluid flow line system. In particular, but not exclusively, the present invention relates to a method and apparatus for routing and re-routing the flow of radioactive sludge from a number of independent sources through a single outlet of a fluid flow line system.

### BACKGROUND

Throughout this document, the term “fluid” is intended to relate to any substance that is able to flow (continually deform under an applied shear stress) along a fluid flow line system. The fluid may comprise a liquid, gas, plasma and/or solid substance. The fluid may include a mixture of such substances. For example, the fluid may comprise a solid suspended or entrained in a liquid. Examples of this type of fluid include a radioactive sludge, formed in fuel rod storage ponds, including radioactive and optionally other solid substances suspended in liquid water and also a fluid comprising floc particles, generated by a flocculation process, suspended in a liquid.

A fluid flow line system is typically used to transfer a fluid from one or more fluid sources to one or more intended destinations. Fluid flow line systems generally include pipes which may be rigid or flexible. When there is more than one fluid source and/or intended destination the fluid flow line system commonly includes multiple branch fluid flow lines. The fluid flow line system may also include multiple branch flow lines to transfer fluid from different areas of a fluid source and/or to transfer fluid to different areas of an intended destination. The fluid flow line system may be configured such that all the branch fluid flow lines may be permanently connected to or integrated with a “master” fluid flow line. Alternatively, the fluid flow line system may be configured such that only a selected branch fluid flow line may be connected to the master fluid flow line at any one time.

When every multiple branch fluid flow line is permanently interconnected with the master fluid flow line, the flow of fluid along the fluid flow line system may be selected using a valve. The valve is arranged to open and close the branch fluid flow lines as required such that fluid may flow along at least one selected branch fluid flow line and the master fluid flow line. When appropriate, the valve may be activated to open and close the branch fluid flow lines such that fluid may be re-routed to flow along a selected branch fluid flow line and the master fluid flow line.

A fluid flow line system comprising multiple branch fluid inlet flow pipes, at least one actuated valve and a fluid outlet flow pipe is commonly used to transfer radioactive sludge from multiple fuel rod storage ponds to a radioactive sludge processing plant. The fluid flow line system may be configured such that a least one branch fluid inlet flow pipe extends from each fuel rod storage pond and interconnects with a fluid outlet flow pipe extending towards the radioactive sludge processing plant. The fluid flow line system may be further configured such that multiple branch fluid inlet flow pipes extend from different areas of each fuel rod storage pond. In this type of fluid flow line system, a valve is provided to control the flow of the radioactive sludge along the fluid flow line system and divert the flow from the fuel storage rod ponds as required. The valve is configured to open and close the branch fluid inlet flow pipes such that only radioactive sludge from a selected fuel rod storage pond and/or from a selected area of a fuel rod storage pond can be transferred to the processing plant. The flow of radioactive fluid may be diverted to flow from an alternative fuel rod storage pond or alternative area of the same fuel rod storage pond by activating the valve to open and close the branch fluid inlet flow pipes as appropriate.

Although commonly used, there are a number of problems associated with this type of fluid flow line system and particularly the use of actuated valves. For example, this type of arrangement is generally unsuitable for transferring a solid or solid suspended in a liquid because the fluid may collect in “dead leg” regions of the closed branch fluid flow lines and form plugs of solid material. The plugs may then obstruct the flow of fluid when the valve, and thereby the branch fluid flow line, is subsequently opened. Actuated valves conventionally use polymeric seals to provide a sealing action and inhibit any leakage of fluid along a closed branch fluid flow line. In use, the polymeric seals are subject to substantial wear and tear, require regular maintenance in order to avoid valve failure and prevent any leakage of fluid. The need for regular maintenance is expensive and it leads to significant plant operation down-time. Also, when the fluid flow line system is used to transfer radioactive fluid, the maintenance of the seals may lead to the risk of a radiation dose uptake by maintenance staff. Moreover, actuated valves are complex, bulky and expensive structures and also include control systems which are complicated to operate.

In a fluid flow line system where only one branch line is connectable to a master fluid line at any one time, the flow of fluid is selected and controlled by aligning and mating a certain branch fluid flow line to the master flow line. The selected branch fluid flow line may extend from one of multiple fluid sources or it may extend from one of multiple areas of a single fluid source. The flow of fluid may then be re-routed by disconnecting the original branch flow line and then aligning and mating a different branch flow line to the master flow line (extending from a different fluid source or a different area of the same fluid source). This type of fluid flow line system can include multiple flexible inlet hoses that each extend from a different fluid source and/or extend from different areas of the same fluid source. These are connectable with a flexible outlet pipe. Since only one inlet hose pipe may be connected to the outlet hose pipe at any one time, the fluid flow line system is configured to allow only fluid to flow from a selected fluid source and/or selected area of a fluid source along the inlet hose pipe and outlet hose pipe to the intended destination. The fluid flow may be diverted by disconnecting a first inlet hose pipe and aligning and coupling a second inlet hose pipe to the flexible outlet pipe.

As with the previously mentioned type of flow line system, there are a number of problems associated with using this type of fluid flow line system. For example so as to avoid any leakage of fluid, it is essential that the relevant branch fluid flow line and master fluid flow line are accurately aligned prior to mating. However, it has been found that in practice this is difficult to achieve. It is particularly difficult to accurately align the branch pipe and mater pipe in a predictable, reliable and low maintenance manner when the fluid flow line system is arranged in a confined space and/or it is used to transfer radioactive sludge and is therefore arranged below the pond surface level. It has also been found that the connection or coupling of the branch fluid flow line and master fluid flow line is compromised, and may even fail, if the mating surfaces and/or seals are exposed to the fluid when making and breaking the coupling connection.

It is an aim of the present invention to at least partly mitigate the above-mentioned problems.

It is an aim of certain embodiments of the present invention to address or overcome at least some of the problems associated with conventional fluid line systems by using a diverter device to divert the flow of fluid along a fluid flow line system. The diverter device seeks to address or overcome at least some of the above-mentioned problems because it is simple, reliable, compact, requires minimal effort to operate and does not require fluid flow line movement.

### BRIEF SUMMARY OF THE DISCLOSURE

According to a first aspect of the present invention there is provided a diverter device for diverting the flow of fluid along a fluid flow line system comprising: a housing having at least a first pipeline port, a second pipeline port and a third pipeline port; a diverting member rotatably mounted within the housing and having a fluid flow channel; whereby in use the diverting member is rotatable between at least a first position wherein the fluid flow channel is in fluid communication with the first pipeline port and the third pipeline port; and a second position wherein the fluid flow channel is in fluid communication with the second pipeline port and the third pipeline port.

According to a second aspect of the present invention there is provided a fluid flow line system for selecting a flow path for a flow of fluid, comprising:
a first routing device comprising:
(i) a housing having at least two inlet pipeline ports connectable to inlet pipelines of a fluid flow line system and an outlet pipeline port; and
(ii) a diverting member rotatably mounted within the housing and having a fluid flow channel, wherein the diverting member is rotatable such that the fluid flow channel can be selectively located in fluid communication with any one of the inlet pipeline ports and the outlet pipeline port; and
a second routing device comprising:
(i) a housing having an inlet pipeline port and at least two outlet pipeline ports connectable to outlet pipelines of the fluid flow system; and
(ii) a diverting member rotatably mounted within the housing and having a fluid flow channel, wherein the diverting member is rotatable such that the fluid flow channel can be selectively located in fluid communication with the inlet pipeline port and any one of the outlet pipeline port; wherein
the outlet pipeline port of the first routing device is coupled to the inlet pipeline port of the second routing device.

According to a third aspect of the present invention there is provided a method for selecting a flow path for the flow of a fluid along a fluid flow line system, comprising the steps of:
rotating a diverting member in a housing comprising at least a first pipeline port, a second pipeline port and a third pipeline port, said diverting member comprising a fluid flow channel, to thereby selectively locate the fluid flow channel in at least a first position in which the fluid flow channel is in fluid communication with the first pipeline port and the third pipeline port or a second position in which the fluid flow channel is in fluid communication with the second pipeline port and the third pipeline port.

The diverter device may be arranged, mounted or integrated as part of a fluid flow line system to divert the flow of fluid such that it may flow along the fluid flow line system from a predetermined fluid source to a predetermined destination.

### BRIEF DESCRIPTION OF THE DRAWINGS

Embodiments of the present invention will now be described hereinafter, by way of example only, with reference to the accompanying drawings in which:

FIG. 1 depicts a perspective view of a diverter device;

FIG. 2 depicts a side view of a diverting member of the diverter device;

FIG. 3 depicts a perspective view of the diverting member of the diverter device;

FIG. 4 depicts a further perspective view of the diverting member of the diverter device;

FIG. 5 depicts the diverter device connected to an inlet pipeline and an outlet pipeline;

FIG. 6 depicts an exploded view of the diverter device;

FIG. 7 depicts an plan view of a fluid flow line system comprising the diverter device;

FIG. 8 depicts a side view of the fluid flow line system.

In the drawings like reference numerals refer to like parts.

### DETAILED DESCRIPTION

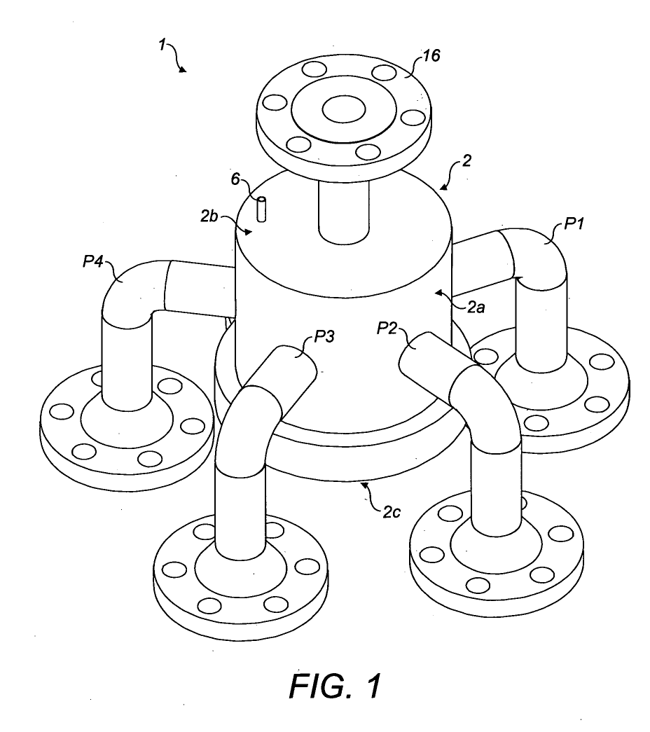

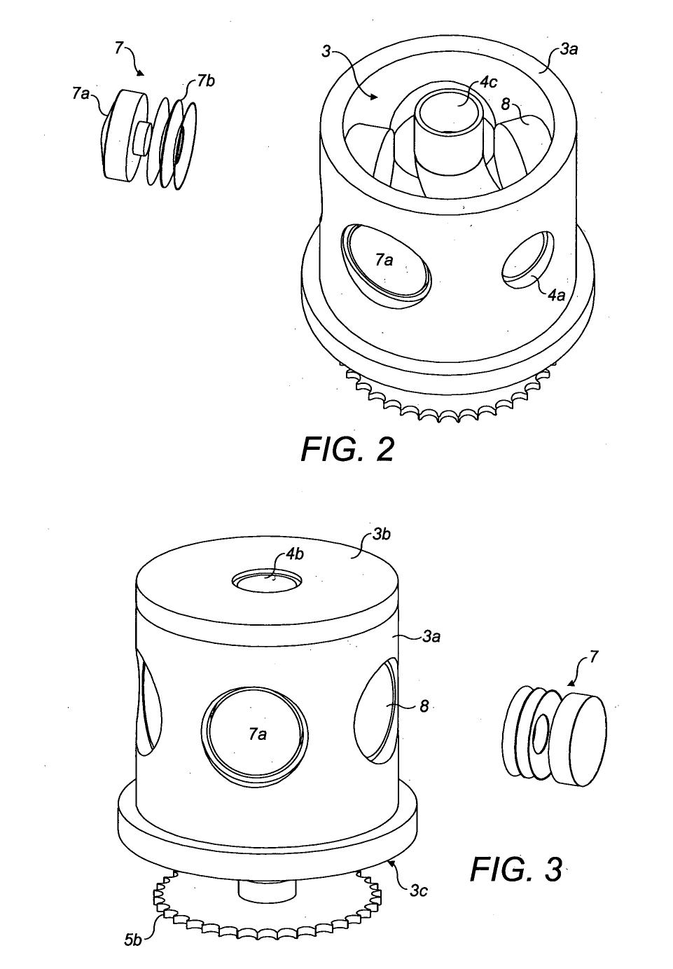

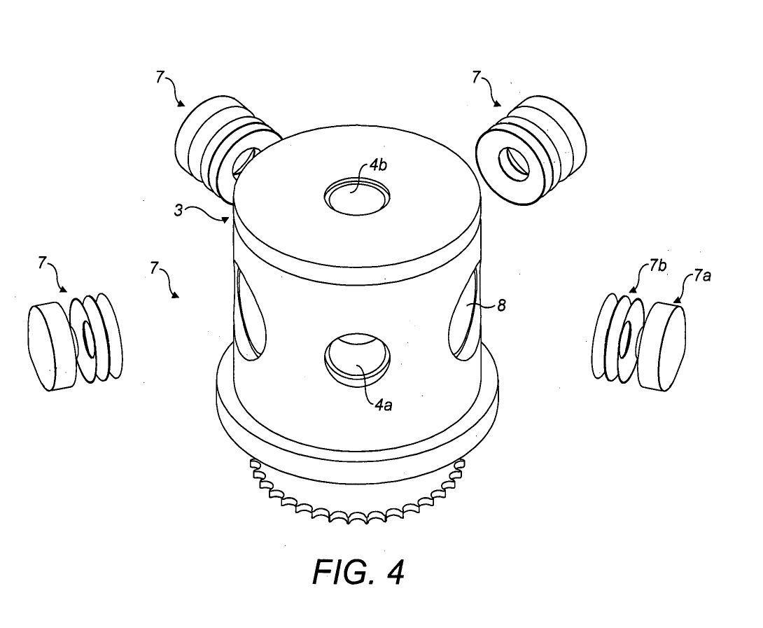

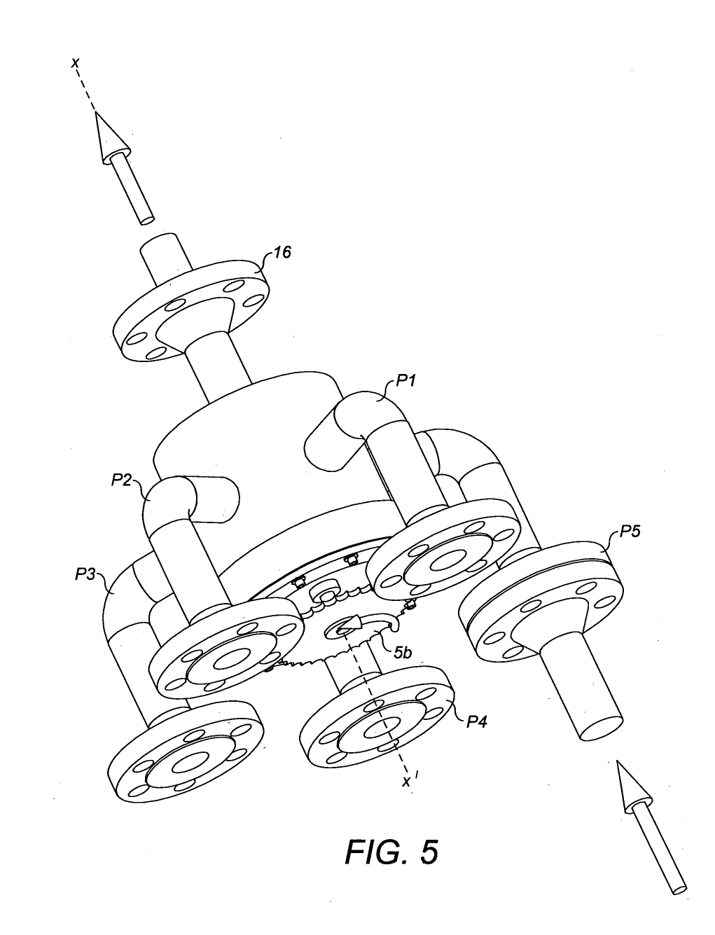

FIGS. 1 to 6 depict an example of a diverter device (1) according to the first aspect of the invention. This particular diverter device is suitable for diverting the flow of radioactive sludge along a fluid flow line system extending from at least one fuel rod storage pond to at least one radioactive treatment or processing plant.

The diverter device (1) comprises a housing (2). The housing (2) has a cylinder-like shape with a side wall (2a), a first end wall (2b) and second end wall (2c). The diverter device may be fixed in any one of multiple orientations such as horizontally, vertically or on the skew. This means the device is versatile and can be utilised in a wide variety of places.

The diverter device comprises six pipeline ports (P1, P2, P3, P4, P5, P6).

Five of the pipeline ports (P1, P2, P3, P4, P5) are arranged equidistant around the side wall (2a) of the housing. These particular pipeline ports comprise an aperture (not shown) extending through the side wall of the housing. Each of the five pipeline ports further comprise an elongate portion (P1a, P2a, P3a, P4a, P5a) that extends outwardly from the aperture in the housing wall. It can be seen in the Figures that the elongate portion is essentially a pipe-like portion that can direct fluid to and from the respective aperture formed in the housing side wall. The elongate portions have a generally L-shape configuration such that the fluid is turned by approximately 90° as it flows along the elongate portion. Each of the five pipeline ports further comprise a base portion (P1b, P2b, P3b, P4b, P5b) arranged at the distal end of the elongate portion. The base portion may be configured to be securable to a further member. For example, the base portion may be configured to secure the pipeline port to a member within a fluid flow line system. The base portion may optionally be supported in other ways.

The sixth pipeline port (P6) is arranged centrally in the first end wall (2b) of the housing. The sixth pipeline port comprises an aperture (not shown) extending through the first end wall of the housing. The pipeline port further comprises an elongate portion (P6a) that extends outwardly from the aperture in the housing wall. The elongate portion is effectively a pipe-like portion that can direct the fluid to and from the aperture formed in the housing first end wall. The pipeline port further comprises a base portion (P6b) arranged at the distal end of the elongate portion. The base portion is configured to be securable to a further member. For example, the base portion may be configured to secure the pipeline port to a member within a fluid flow line system.

Each of the pipeline ports (P1, P2, P3, P4, P5, P6) are configured to receive, engage or mate with a respective pipeline. The pipeline ports may further comprise connecting means to interconnect, engage or couple the respective pipelines and pipeline ports together.

The diverter device may be arranged within a fluid flow line system comprising up to five inlet pipelines (extending from up to five different fluid sources and/or different outlets, regions etc. of a fluid source) and a single outlet pipeline (extending to an intended destination). Thus, the five pipeline ports (P1, P2, P3, P4, P5) arranged around the side wall of the housing may be inlet pipeline ports that are configured to receive, engage etc. the inlet pipelines and the sixth pipeline port may be an outlet pipeline port that is configured to receive, engage etc. an outlet pipeline. The diverter device may alternatively be arranged within a fluid flow line system comprising a single inlet pipe (extending from a fluid source) and up to five outlet pipelines (extending to up to five different intended destinations and/or different inlets, regions etc. of an intended destination). Thus in this case, the five pipeline ports (P1, P2, P3, P4, P5) are outlet pipeline ports that are configured to receive, engage etc. the outlet pipelines and the sixth pipeline port is an inlet pipeline port.

The housing (2) and pipeline ports (P1, P2, P3, P4, P5, P6) are manufactured from stainless steel. Optionally other rigid materials may be utilised.

The diverter device further comprises a diverting member (3). The diverting member is configured to closely fit within the internal structure of the housing (2). The diverting member has a corresponding cylinder-like shape with a side wall (3a), first end wall (3b) and second end wall (3c).

The diverting member (3) comprises a fluid channel (4) extending through the diverting member. The fluid channel (4) comprises a first aperture (4a) formed to extend through the side wall (3a) of the diverting member, a second aperture (4b) formed to extend through the first end wall (3b) of the diverting member and a passageway (4c) that extends between the first aperture (4a) and second aperture (4b). The fluid channel (4) is essentially a conduit such that fluid can flow through the diverting member. The passageway (4ca) has a generally L-shaped configuration such that fluid is turned approximately 90° as it flows through the diverting member. The diverting member may be solid, including a passageway through the body or hollow with a tube connecting the two apertures.

The diverting member (3) is rotatably mounted within the housing (2). The diverting member is mounted to rotate about a longitudinal axis of the diverting member and housing (X-X′). The diverting device comprises rotating means (5) to rotate the diverting member. In this particular example, the rotating means include a bearing (5a) and gear wheel (5b). The gear wheel (5b) is coupled to second end wall (3c) of the diverting member. The bearing (5a) is arranged between the second end wall (3c) of the diverting member and second end wall (2c) of the housing and it is retained in place by a retaining ring (5c). It can be seen in the Figures that the wheel portion of the gear wheel (5b) is arranged externally to the housing of the diverter device.

The diverting member (3) is mounted to rotate within the housing (2) such that the fluid channel (5) may be arranged in fluid communication with any one of the five pipeline ports (P1, P2, P3, P4, P5) arranged around the side wall (2a) of the housing and the sixth pipeline port (P6) arranged centrally in the first end wall (2b) of the housing. The fluid channel (5) is considered to be in fluid communication with the pipeline ports when the first aperture (5a) is arranged adjacent the aperture of one of the five pipeline ports formed in the side wall of the housing and the second aperture (4b) is arrange adjacent the aperture of the sixth pipeline port formed in the first end wall of the housing.

Indexing marks may be included to assist personnel when a fluid communication route is changed. The indexing marks help ensure that the rotatable diverting member is appropriately aligned within the housing to duly connect a desired inlet port to a desired outlet port.

When the diverting member (3) is arranged in fluid communication with any one of the five pipeline ports (P1, P2, P3, P4, P5) and the sixth pipeline port (P6), the diverting member and housing are arranged such that fluid can flow through one of the pipeline ports (which ever is configured as the inlet pipeline port), along the fluid channel (5) and out through the other pipeline port (which ever port is configured as the outlet port).

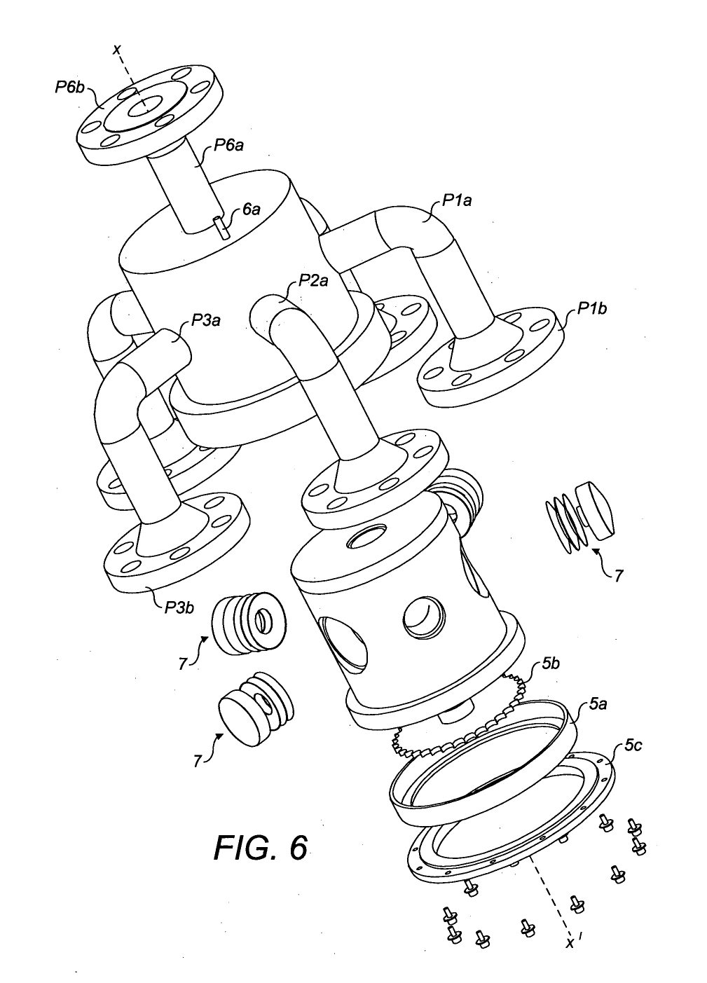

In FIG. 6, the diverting device is configured such that it comprises five inlet pipeline ports (P1, P2, P3, P4, P5) and an outlet pipeline port (P6). The diverting member (3) is arranged in fluid communication with inlet pipeline port (P5) and outlet pipeline port (P6). Thus, fluid can flow along an inlet pipeline connected to inlet pipeline port P5, into the diverter device via inlet pipeline port P5, through the diverting member (3) and out through the outlet pipeline port P6 to the outlet pipeline.

The diverting member may be further rotated within the housing between the five different pipeline ports formed in the side wall of the housing in order to divert or re-route the fluid. For example, when the diverter device is configured within a fluid flow system such that the diverter device comprises five inlet pipeline ports and a single pipeline port, the diverter device may divert, re-route or change the direction of fluid flow by rotating the diverting member to a first position, second position, third position, fourth position and fifth position—wherein in the first position the fluid channel (4) is in fluid communication with the first inlet pipeline port (P1) and the sixth outlet pipeline port (P6), in the second position the fluid channel (4) is in fluid communication with the second inlet pipeline port (P2) and the sixth outlet pipeline port (P6), in the third position the fluid channel (4) is in fluid communication with the third inlet pipeline port (P3) and the sixth outlet pipeline port (P6), in the fourth position the fluid channel (4) is in fluid communication with the fourth inlet pipeline port (P4) and the sixth outlet pipeline port (P6) and in the fifth position the fluid channel (4) is in fluid communication with the fifth inlet pipeline port (P5) and the sixth outlet pipeline port (P6). In this example, the diverter device may be used to divert or re-route the flow of fluid along the fluid flow line system from five different fluid sources and/or different regions etc. of a fluid source to an intended destination.

In another example, when the diverter device is configured within a fluid flow system such that diverter device comprises a single inlet pipeline port and five outlet pipeline ports, the diverter device may diver, re-route or change the direction of fluid flow by rotating the diverting member to a first position second position, third position, fourth position and fifth position—wherein in the first position the fluid channel (4) is in fluid communication with the inlet pipeline port (P6) and the first outlet pipeline port (P1), in the second position the fluid channel (4) is in fluid communication with the inlet pipeline port (P6) and the second outlet pipeline port (P2), in the third position the fluid channel (4) is in fluid communication with the inlet pipeline port (P6) and the third outlet pipeline port (P3), in the fourth position the fluid channel (4) is in fluid communication with the inlet pipeline port (P4) and the fourth outlet pipeline port (P4) and in the fifth position the fluid channel (4) is in fluid communication with the inlet pipeline port (P5) and the fifth outlet pipeline port (P6). In this example, the diverter device may be used to divert or re-route the flow of fluid along the fluid flow line system from a fluid source to five different intended destinations and/or different regions etc. of an intended destination.

As with the housing and pipeline ports, the diverting member is manufactured from stainless steel. Other rigid materials could of course be utilised.

When the diverter device is in use, a flush fluid (not shown) is provided in the internal space between an inner surface of the housing and an outer surface of the diverting member. The flush fluid is pressurised such that it has a fluid pressure that is higher than that of the fluid flowing along the fluid flow line system. The flush fluid circulates or flows around the internal space. The flush fluid provides a sealing action between the housing and diverting member. The flush fluid particularly provides a sealing action around the apertures of the housing and the diverting member such that the leakage of any fluid from the fluid flow line system is minimised. Due to the higher pressure and flow of the flush fluid, the flush fluid has a positive flow and mixes with fluid of the fluid flow line system as it flows through the diverter. The volume and pressure of the flush fluid is thereby controlled so as to minimise the amount of mixing.

The flush fluid also further provides a cleaning action within the diverting device to help keep at least the inner surface (2d) of the housing and the outer surface (3d) of the diverting member clean.

The flush fluid also provides a lubricating action within the diverter device. For example, it helps to lubricate the rotating means mounted within the housing.

The diverter device further comprises a flush fluid inlet port (6) to introduce the higher pressure flush fluid into the internal space between the housing and diverting member. The flush fluid inlet port (6) comprises an aperture (not shown) extending through a wall of the housing. In this particular example, the aperture extends through the first end wall (2b) of the housing. The flush fluid inlet port further comprises an elongate portion (6a). The elongate portion (6a) is configured to receive or engage with a pipeline extending from a flush fluid source. The elongate portion may comprise connecting means to connect, engage or couple with the flush fluid source pipeline.

The diverter device is configured such that the flush fluid exits the internal space of the diverter device via the at least one outlet pipeline port. The volume and pressure of the flush fluid is controlled such that the volume of flush fluid that exits the diverter device is minimised.

In this particular example, the flush fluid is demineralised water. Other liquids or gases could of course be utilised.

When the diverting member is arranged in fluid communication with one of the pipeline ports arranged around the side wall of the housing (e.g. P1) and the pipeline port formed in the first end wall of the housing (P6), the four further pipeline ports (e.g. P2, P3, P4, P5) arranged around the side wall of the housing are redundant and remain open. Thus, flush fluid may freely exit the diverter device via the redundant pipeline ports. The diverter device further comprises four capping members (7) to at least substantially close or cap each of the respective redundant pipeline ports in the side wall of the housing. By capping the redundant pipeline ports the leakage of flush fluid through these ports is prevented or at least minimised. Where more or less than five pipeline ports are utilised according to further embodiments of the present invention an appropriate number (one less than the number of ports) of caps would of course be utilised.

The capping members (7) are mounted in recesses or housings (8) formed within the diverting member. The capping members are configured (shaped and arranged) equidistant around the diverting member such that they coincide and can close the redundant pipeline ports as required subsequent to rotation of the diverting member.

Each capping member (7) comprises a head portion (7a) that is configured to at least substantially extend over the aperture of the redundant pipeline ports. Each capping member (7) also comprises spring loading means (7b), such as a helical spring to bias the cap. The head portions (7a) are spring loaded such that they may extend from the respective recesses (8) to at least substantially resiliently close the apertures of the redundant pipeline ports when the other pipeline port formed in the side wall is aligned in fluid communication with the diverting member and they may also return back into the respective recesses (8) as the diverting member is rotated to a new position.

The head portions (7a) of the capping members are formed from a polymeric material such as EPDM. The helical spring is formed from stainless steel. Other materials could of course be utilised.

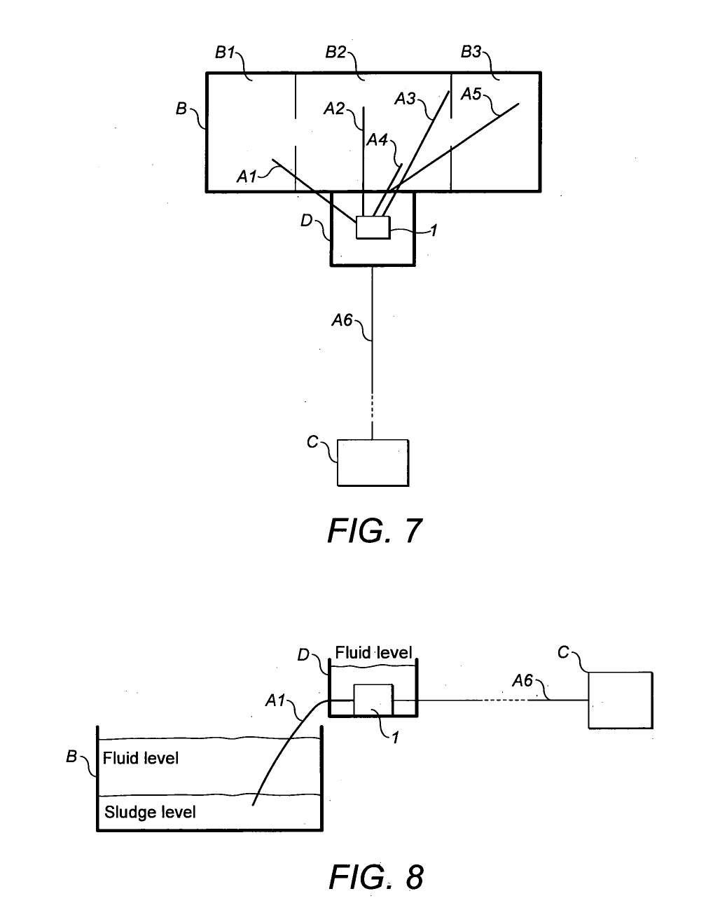

FIGS. 7 and 8 relate to an example of a radioactive sludge flow line system comprising the diverter device (1). The flow line system comprises five inlet pipeline (A1, A2, A3, A4, A5) and an outlet pipeline (A6). The pipelines are formed from a polymeric, normally flexible material. The pipelines, are shielded as they normally lie below a water surface. The outlet pipelines can be encased in concrete or stainless steel or other suitable material so as to minimise radiation.

The flow line system is configured to transfer radioactive sludge from a fuel rod storage pond (B) to a radioactive treatment plant (C). The fuel rod storage pond is divided into three sections (B1, B2, B3) that are connectable via sluice gates. Radioactive sludge typically collects in the bottom of the pond. The radioactive sludge may collect in the pond up to a predetermined level. FIGS. 7 and 8 shows how the five inlet pipelines are arranged such that they extend into the radioactive sludge in the different areas of the pond. The diverting device can be mounted under the surface of shielding water in a storage pond. The diverting device can be mounted under a considerable depth of water. Water can thus be used to shield the diverting device. Movement of the pipes to the respective ports will be achieved from a remote control station situated above the water level, where the indexing device will be located. Motion is achieved by means of a rigid, or semi rigid drive, such as a chain.

Each of the five inlet pipelines are connected to a respective inlet port of the diverter device. The outlet pipeline is connected to the respective outlet port of the diverter.

So as help to minimise radiation close to personnel, the diverter device is arranged in a fluid in a pond (D). Any suitable fluid may be used, such as water.

At least one pump is provided to help pump the radioactive sludge out of the pond and along the flow line system (not shown).

The diverter device is provided to re-route the flow of radioactive sludge, at desired times, along the flow line system such that it can be extracted from the different regions of the pond. As explained above, the diverting member of the re-router may be rotated between a first position, second position, third position, fourth position and fifth position such that radioactive sludge can flow from any one of the five inlet pipes to the processing plant. Moreover, the diverting member may be rotated from one position to another such that flow of radioactive sludge can change from one particular inlet pipeline to another particular inlet pipeline.

The diverter device is suitable for diverting the flow of any fluid that is able to flow along a fluid flow line system. The fluid may comprise a liquid, gas, plasma and/or solid material. The fluid may include one or more different materials, for example the fluid may comprise a mixture of different liquid materials or it may comprise a solid suspended or entrained in a liquid. The fluid may comprise a radioactive sludge or slurry comprising radioactive solids suspended in a liquid. The radioactive sludge may be formed in one or more fuel rod storage ponds and comprise radioactive solids formed as the rods and/or encasing materials corrode over time. The radioactive components of the sludge may comprise Caesium 137 and/or Strontium 90. Since the fuel rod storage ponds may be open to the elements, the radioactive sludge may comprise other solid materials such as plant-like debris and/or guano. The fluid may alternatively comprise floc particles suspended in a liquid that are formed during a flocculation process. The floc may comprise ferric hydroxide or ferric alumino hydroxide.

The housing of the diverter device comprises a first end wall, second end wall and at least one side wall. The housing preferably has a cylindrical form with a first end wall, second end wall and side wall. Preferably, the housing is configured and arranged within a fluid flow line system.

The housing comprises at least three pipeline ports. Each pipeline port is configured such that it can receive or engage a respective pipe or pipeline of a fluid flow line system. The at least three pipeline ports preferably comprise connecting means to connect, engage or couple with the pipes or pipelines of a fluid flow line system. The first pipeline port is connectable to a first pipeline, the second pipeline port is connectable to a second pipeline and the third pipeline port is connectable to a third pipeline of a fluid flow line system.

The housing is configured such that at least two pipeline ports (the first pipeline port and the second pipeline port) are arranged/formed at the at least one side wall of the housing and a further pipeline port (the third pipeline port) is arranged/formed at the first end wall of the housing. The at least two pipeline ports are preferably arranged around the at least one side wall of the housing, and they are even more preferably arranged equidistant around the at least one side wall of the housing

Each pipeline port comprises an aperture formed in the requisite wall of the housing. The apertures extend through the side wall and first end wall of the housing. The pipeline ports may further comprise an elongate portion extending from each respective aperture. The pipeline ports may also comprise a base portion arranged at the distal end of the elongate portion. The base portion may be configured to be securable to a securing member.

The configuration of the diverter device (e.g. the number of pipeline ports) and its arrangement within a fluid flow line system (e.g. the connection of the diverting device to the inlet and outlet pipes) is dependent on the number of fluid sources, the number of outlets, regions etc. of each fluid source, the number of intended destinations and the number of inlets, regions etc. of each intended destination. For example:
(i) the diverter device may be configured and arranged such that fluid can flow from any one fluid source specifically selected from a multiple fluid sources to an intended destination and/or fluid can flow from any one outlet, region, section or area of a fluid source selected from multiple outlets, regions, sections or area of a fluid source. This may be achieved by configuring the diverter device such that it includes multiple (at least two) inlet pipeline ports and an outlet pipeline port, whereby the inlet pipeline ports are connectable to inlet pipelines extending from the multiple fluid sources and/or extending from the multiple outlet, regions etc. of a fluid source and the outlet pipeline port is connectable to an outlet pipeline extending to the intended destination. More specifically, if there are two fluid sources and one intended destination, the diverter device is configured and arranged within the fluid flow line system such that the first pipeline port is connected to a first inlet pipeline extending from a first fluid source, the second pipeline port is connected to a second inlet pipeline extending from a second fluid source and the third pipeline port is connected to a third outlet pipeline extending to the intended destination; or
(ii) the diverter device may be configured and arranged such that fluid can flow from a fluid source to any one intended destination specifically selected from multiple intended destinations and/or any one inlet, region, section or area of an intended destination selected from multiple inlets, regions, sections or areas of an intended destination. This may be achieved by configuring the diverter device such that it includes an inlet pipeline port and multiple (at least two) outlet pipeline ports, whereby the inlet pipeline port is connectable to an inlet pipeline extending from the fluid source and the outlet pipeline ports are connectable to outlet pipelines extending to the multiple intended destinations and/or extending to multiple inlets, regions etc. of an intended destination. More specifically, if there is one fluid source and two intended destinations, the diverter device is configured and arranged within the fluid flow line system such that the first pipeline port is connected to a first outlet pipeline extending to a first intended destination, the second pipeline port is connected to a second outlet pipeline extending to a second intended destination and the third pipeline port is connected to a third inlet pipeline extending from the fluid source.

The diverting member is configured (shaped and sized) such that it closely fits within the internal structure of the housing. Hence, the diverting member preferably comprises a corresponding first end wall, corresponding second end wall and at least one corresponding side wall. If the housing has a cylindrical form, the diverting member may also have a cylindrical form with a corresponding first end wall, corresponding second end wall and corresponding side wall.

The diverting member comprises a fluid channel. The fluid channel is a conduit that extends through the diverting member from the side wall to the first end wall. The fluid channel comprises a first orifice/aperture formed in the side wall of the diverting member, a second orifice/aperture formed in first end wall of the diverting member and a passageway that extends between the first orifice and second orifice.

As mentioned above, the diverting member is mounted to rotate within the housing. The diverting member is mounted to rotate about a longitudinal axis of diverting member and housing. The diverting device preferably comprises rotating means to rotate the diverting member within the housing. The rotating means may include chain drive means, bearings, gear wheel etc. or any other suitable conventional rotating means. The diverting means may be rotated manually or automatically by electronic control means.

The diverting member is mounted to rotate within the housing such that the fluid channel may be arranged in fluid communication with any one of the pipeline ports formed in the sidewall of the housing and the pipeline port formed in the first end wall of the housing. The fluid channel is deemed to be in fluid communication with the pipeline ports when the first orifice of the fluid channel is arranged adjacent the aperture of any port formed in the sidewall of the housing and the second orifice of the fluid channel is arranged adjacent the aperture of the port formed at the first end wall of the housing. When the fluid channel is arranged in fluid communication with any one of the pipeline ports formed in the sidewall of the housing and the pipeline port formed in the first end wall, the diverting member and housing are essentially arranged such that in use fluid may flow in through one of the pipeline ports (which ever port is configured as the inlet pipeline port), along the fluid channel of the diverter and out through the other pipeline port (which ever port is configured as the outlet pipeline port).

By rotatably mounting the diverting member, the diverting member may be rotated within the housing between the different pipeline ports formed in the sidewall of the housing in order to divert, re-route or change the direction of the flow of fluid along a fluid flow line system.

For example, when the diverter device comprises a housing having a first inlet port and second inlet port formed in the sidewall of the housing and a third outlet port formed in the first end wall of the housing, the diverter device may change the direction of the flow of fluid by rotating the diverting member between a first and second position—wherein in the first position the fluid channel of the diverting member is in fluid communication with the first inlet port and the third outlet port (such that in use fluid flows into the diverter device through the first inlet port, along the fluid channel and out through the third outlet port) and in the second position the fluid channel of the diverting member is in fluid communication with the second inlet port and the third outlet port (such that in use fluid flows into the diverter device through the second inlet port, along the fluid channel and out through the third outlet port). In this example, the diverter device may be used to divert or re-route the flow of fluid along a fluid flow line system from two different fluid sources or from two different regions etc. of a fluid source.

In another example, when the diverter device comprises a housing having a first outlet port and second outlet port formed in the sidewall of the housing and a third inlet port formed in the first end wall of the housing, the diverter device may divert the direction of the flow of fluid by rotating the diverting member between a first and second position—wherein in the first position the fluid channel of the diverting member is in fluid communication with the first outlet port and the third inlet port (such that in use fluid flows into the diverter device through the third inlet port, along the fluid channel and out through the first outlet port) and in the second position the fluid channel of the diverting member is in fluid communication with the second outlet port and the third inlet port (such that in use fluid flows into the diverter device through the third inlet port, along the fluid channel and out through the second outlet port). In this example, the diverter device may be used to divert or re-route the flow of fluid along a fluid flow line system to two different destinations or to two different regions etc. of a destination.

Preferably, the diverter device further comprises a flush fluid. The flush fluid is provided in the internal space between an inner surface of the housing and an outer surface of the diverting member. The flush fluid is pressurised such that it has a fluid pressure higher than that of the fluid flowing along the fluid flow line system. The flush fluid is directed to circulate or flow around the inner space in a predetermined direction. Due to the higher pressure and of flow of the flush fluid, the flush fluid provides a sealing action between the housing and the diverting member, preferably around the apertures of the ports and around the orifices of the fluid channel such that any leakages of the flow line system fluid are at least minimised. The flush fluid provides a positive flow between the at least one inlet port and the flow channel and between the flow channel and the at least one outlet port such that a certain volume of flush fluid mixes with the flow line system fluid and/or escapes through the at least one outlet pipeline port. The volume and pressure of flush fluid is therefore preferably controlled such that the volume of flush fluid mixing with the fluid of the fluid flow line system and/or escaping via the at least one outlet pipeline port is minimised.

It has been found that the flush fluid also provides a cleaning action within the diverter device. The flush fluid provides a cleaning action as it circulates around the inner space between the housing and the diverting member and washes over the internal surfaces of the diverter device. For example, the flush fluid helps to clean the inner surface of the housing and the outer surface of the diverting member. The flush fluid may be used to flush out the diverter and clean the surfaces of the fluid channel when the fluid flow line system is not in use. The flush fluid may also help to clean the rotating means e.g. bearings.

The flush fluid may also provide a lubricating action within the diverter. For example, the flush fluid may help to lubricate the rotating means and/or internal surfaces within the diverter.

The diverter device preferably comprises a flush fluid inlet port to introduce the higher pressure flush fluid into the internal space between the inner surface of the housing and the outer surface of the diverting member. The flush fluid inlet port preferably comprises an aperture extending through a wall of the housing. The flush fluid inlet port may further comprise an elongate portion that extends from the aperture. The flush fluid inlet port may be configured to receive or mate with a pipeline extending from a flush fluid source. The flush fluid inlet port may further comprise connecting means to connect, engage or couple the port with a pipeline extending from a flush fluid source. The flush fluid inlet port may also preferably be configured to introduce the flush fluid such that it circulates around the inner space in a predetermined direction.

The flush fluid is compatible with the fluid flowing along the fluid flow line system. The flush fluid is preferably a liquid such as treated water (e.g. demineralised water and/or clean water).

Since at least two pipeline ports are formed in the sidewall of the housing at least one pipeline port will always be “redundant” and remain open when one of the pipeline ports is aligned in fluid communication with the fluid channel of the diverting member. Thus, flush fluid may freely exit the diverter device via the at least redundant pipeline port. The diverter device therefore preferably further comprises at least one capping member to at least substantially close or cap each respective redundant pipeline port in the sidewall of the housing. By capping the at least one redundant pipeline port the flush fluid is prevented from exiting through the at least one redundant pipeline port.

The at least one capping member is preferably mounted in a recess or housing formed within the diverting member. The at least one capping member is configured (shaped and arranged within the diverting member) such that it coincides and can at least substantially close the aperture of the redundant pipeline ports as required. The at least one capping member preferably comprises a head portion that is configured such that it can extend across, within or over and thereby at least substantially closes the aperture of the redundant pipeline port. The head portion is preferably spring loaded such that it may resiliently extend from the recess/housing to at least substantially close the at least one respective redundant pipeline port when the other pipeline port is aligned in fluid communication with the diverting member and it may also return back into the recess/housing as the diverting member is rotated. The head portion may be spring loaded using a helical spring or any other conventional spring loading means.

The housing and diverting member of diverting device are formed from a material that is compatible with the fluid from the flow line and, when provided, the flush fluid. The housing and/or diverting member of the diverter device may be manufactured from stainless steel or any other conventional material in accordance with the application of the diverter device. The at least one capping member must also be formed from a material that is compatible with the fluid from the flow line. The capping member may be formed from a polymeric material such as EPDM or any other conventional material in accordance with the application of the diverter device.

The outlet pipeline of the first diverting device and the inlet pipeline port of the second diverting device may be directly coupled using connecting means or they may be indirectly coupled using a further pipe or pipeline.

The pipelines of the fluid flow line system may be substantially rigid or substantially flexible. The pipeline may comprise a polymeric material such as EPDM or any other conventional piping material.

When used to transfer radioactive fluids, the pipelines of the fluid flow line system are preferably shielded to minimise or block any radiation. The pipelines may be shielded using concrete or any other conventional shielding material.

The fluid flow line system preferably comprises at least one pumping means to pump the fluid from the at least one fluid source, along the fluid flow line system and to the at least one intended destination.

The at least one inlet pipeline of the fluid flow line system may be connected to at least one fluid source by locating at least one inlet pipeline within the fluid contained within the at least one fluid source, locating at least one inlet pipeline within the fluid at a certain region, section or area of the at least fluid source or by engaging/coupling at least one inlet pipeline with a corresponding outlet port of the at least one fluid source.

Likewise, the at least one outlet pipeline of the fluid flow line system may be connected to the at least one intended destination by locating at least one outlet pipeline within a certain region, section or area of the intended destination or by engaging/coupling at least one inlet pipeline with a corresponding inlet port of the at least one intended destination.

It is to be noted that two or more diverters can be placed in series to increase the routing options.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Apparatus for selecting a flow path for the flow of fluid along a fluid flow line system, comprising:
a housing comprising at least a first pipeline port, a second pipeline port and a third pipeline port; and
a diverting member rotatably mounted within the housing and comprising a fluid flow channel; wherein
the diverting member is rotatable between at least a first position in which the fluid flow channel is in fluid communication with the first pipeline port and the third pipeline port and a second position in which the fluid flow channel is in fluid communication with the second pipeline port and the third pipeline port.

2. Apparatus as claimed in claim 1, further comprising:
the housing comprises at least two pipeline ports arranged in at least one side wall of the housing and a further pipeline port arranged at a first end wall of the housing; wherein
the diverting member is rotatable within the housing such that the fluid flow channel can be configured in fluid communication with any one of the pipeline ports arranged around the side wall of the housing and the further pipeline port arranged at the first end wall of the housing.

3. Apparatus as claimed in claim 2, further comprising:
each of the at least two pipeline ports arranged around the at least one side wall of the housing comprises an aperture extending through the at least one side wall of the housing and the further pipeline port arranged at a first end wall of the housing comprises an aperture extending through the first end wall of the housing; wherein
the fluid flow channel comprises:
a first aperture extending through a side wall of the diverting member;
a second aperture extending through a first end wall of the diverting member; and
a passageway extending between the first aperture and the second aperture.

4. Apparatus as claimed in claim 3, further comprising:
the diverting member is rotatable within the housing such that the first aperture of the fluid flow channel is locatable adjacent to the aperture of any one of the pipeline ports arranged around the at least one side wall of the housing and the second aperture of the fluid flow channel is locatable adjacent the pipeline port arranged at the first end wall.

5. Apparatus as claimed in claim 2, wherein the at least two pipeline ports arranged around the at least one side wall of the housing are inlet pipeline ports connectable to at least two respective inlet pipelines of a fluid flow line system and the further pipeline port arranged at the first end wall of the housing is an outlet pipeline port connectable to an outlet pipeline of a fluid flow line system.

6. Apparatus as claimed in claim 2, wherein the at least two pipeline ports arranged around the at least one side wall of the housing are outlet pipeline ports connectable to at least two respective outlet pipelines of a fluid flow line system and the further pipeline port arranged at the first end wall of the housing is an inlet pipeline port connectable to an inlet pipeline of a fluid flow line system.

7. Apparatus as claimed in claim 1 further comprising rotating means to rotate the diverting member within the housing.

8. Apparatus as claimed in claim 1 further comprising a flush fluid in an internal region between the housing and the diverting member.

9. Apparatus as claimed in claim 8 wherein the flush fluid has a fluid pressure higher than a system pressure of the flow line system fluid and the flush fluid is directed to flow around the internal region in a predetermined direction and provide a sealing action between the housing and the diverting member.

10. Apparatus as claimed in claim 8, further comprising at least one flush fluid inlet port connectable to a pipeline in fluid communication with a flush fluid source.

11. Apparatus as claimed in claim 8, further comprising at least one capping member arranged to at least substantially close at least one respective redundant pipeline port.

12. Apparatus as claimed in claim 11, wherein the at least one capping member comprises a head portion and a biasing element and is mounted within a respective recess formed in the diverting member.

13. The apparatus as claimed in claim 1 wherein the housing is orientatable in a plurality of optional orientations.

14. The apparatus as claimed in claim 1 wherein the apparatus is submergeable under shielding water.

15. A fluid flow line system for selecting a flow path for a flow of fluid, comprising:
a first routing device comprising:
(i) a housing having at least two inlet pipeline ports connectable to inlet pipelines of a fluid flow line system and an outlet pipeline port; and
(ii) a diverting member rotatably mounted within the housing and having a fluid flow channel, wherein the diverting member is rotatable such that the fluid flow channel can be selectively located in fluid communication with any one of the inlet pipeline ports and the outlet pipeline port; and
a second routing device comprising:
(i) a housing having an inlet pipeline port and at least two outlet pipeline ports connectable to outlet pipelines of the fluid flow system; and
(ii) a diverting member rotatably mounted within the housing and having a fluid flow channel, wherein the diverting member is rotatable such that the fluid flow channel can be selectively located in fluid communication with the inlet pipeline port and any one of the outlet pipeline port; wherein the outlet pipeline port of the first routing device is coupled to the inlet pipeline port of the second routing device.

16. The fluid flow line system as claimed in claim 15 wherein the outlet pipeline port of the first routing device and the inlet pipeline port of the second routing device are directly connected via connecting means or indirectly connected via an interconnecting pipeline.

17. A fluid flow line system comprising:
the apparatus as claimed in claim 1; and
at least two inlet pipelines extending from at least one fluid source and connected to respective inlet pipeline ports of the housing; and
an outlet pipeline connected to the respective outlet pipeline port of the housing and extending to an intended destination.

18. A fluid flow line system comprising:
the apparatus as claimed in claim 1; and
an inlet pipeline extending from a fluid source and connected to the respective inlet pipeline port of the housing; and
at least two outlet pipelines connected to the respective outlet pipeline ports of the housing and each extending to a respective intended destination.

19. A method for selecting a flow path for the flow of a fluid along a fluid flow line system, comprising the steps of:
rotating a diverting member in a housing comprising at least a first pipeline port, a second pipeline port and a third pipeline port, said diverting member comprising a fluid flow channel, to thereby selectively locate the fluid flow channel in at least a first position in which the fluid flow channel is in fluid communication with the first pipeline port and the third pipeline port or a second position in which the fluid flow channel is in fluid communication with the second pipeline port and the third pipeline port.

20. The method as claimed in claim 19, further comprising the steps of:
selectively rotating the diverting member to select a flow path for the flow of fluid between one of a plurality of inlet pipeline ports and an outlet pipeline port.

21. The method as claimed in claim 19, further comprising the steps of:
selectively rotating the diverting member to select a flow path for the flow of the fluid between an inlet pipeline port and one of a plurality of outlet pipeline ports.

22. The method as claimed in claim 19, further comprising the steps of:
sealing each pipeline port not in fluid communication with the flow channel via a respective capping member rotatably locatable proximate to each unused pipeline port.

23. The method as claimed in claim 22, further comprising the steps of:
via a biasing element, biasing each capping member to bias a head portion of the capping member against unused pipeline ports.

24. The method as claimed in claim 19, further comprising the steps of:
preventing flow of fluid from an inlet pipeline port into a region between an inner surface of the housing and an outer surface of the diverting member.

25. The method as claimed in claim 24, further comprising the steps of:
preventing flow of fluid by maintaining a pressure of flush fluid located between the housing and the diverting member above a pressure of fluid in a flow of fluid.

26. The method as claimed in claim 24, further comprising the steps of:
preventing flow of fluid via at least one fluid seal.

27. The method as claimed in claim 24, further comprising the steps of:
lubricating between the inner surface and outer surface via the flush fluid.

28. The method as claimed in claim 19, further comprising the steps of:
rerouting a flow path of a flow of fluid via a single manual action.

29. The method as claimed in claim 19, further comprising the steps of:
the flow of fluid comprises a flow of solids loaded liquor.

30. The method as claimed in claim 19, further comprising the steps of:
the flow of fluid comprises a flow of sludge rich liquor.

31. (canceled)

32. (canceled)
